(19) United States
(12) Patent Application Publication
(10) Pub. No.: US 2025/0248419 A1
(43) Pub. Date: Aug. 7, 2025

(54) PLANT-BASED MEAT COMPOSITION AND METHODS OF MAKING THEREOF

(71) Applicant: Balchem Corporation, Montvale, NJ (US)

(72) Inventors: Nevenka Filipi, Montvale, NJ (US); Chandra Ankolekar, Montvale, NJ (US); Yanni Snowden-Bullock, Montvale, NJ (US); Joan Haselman, Montvale, NJ (US)

(21) Appl. No.: 18/442,769

(22) Filed: Feb. 15, 2024

Related U.S. Application Data
(60) Provisional application No. 63/550,353, filed on Feb. 6, 2024.

(51) Int. Cl. A23J 3/22; A23D 9/04; A23J 3/16; A23L 3/36

(52) U.S. Cl. CPC A23J 3/227; A23B 2/80; A23D 9/04; A23J 3/16

(57) ABSTRACT

Provided are food products that have structures, textures, and other properties comparable to those of animal meat, and that may therefore serve as substitutes for animal meat. Also provided are processes for production of such meat-like food products.

### CLAIM OF PRIORITY

This application claims the benefit of U.S. Provisional Application No. 63/550,353, filed on Feb. 6, 2024, the entire contents of which are herein incorporated by reference in its entirety.

### TECHNICAL FIELD

This invention relates generally to the field of plant-based food products that have structures, textures, and other properties comparable to those of animal meat, and that may therefore serve as substitutes for animal meat. Also provided are processes for production of such ground meat-like food products.

### BACKGROUND

Animal meat is one of the most versatile protein-rich food products available. However, the health and environmental benefits of vegetarian and vegan diets are broadly recognized, and consumers are increasingly making conscious efforts to decrease their intake of animal derived food items and their unhealthy ingredients (e.g., saturated fatty acids, cholesterol).

To meet the rising demand for vegetarian and vegan dietary products and to address the environmental burden associated with animal meat consumption, food scientists have engaged in efforts to develop protein-rich food products that are not derived from animals but provide similar textural properties and nutritional benefits as animal-derived food products. However, such efforts have had limited success, and accordingly consumer satisfaction with and acceptance of the new food products have been low.

Therefore, there exists an unmet need for non-animal-derived protein products that have the structure, texture, and other properties of animal meat, that do not challenge common nutritional sensitivities, and that provide the use versatility and cooking experiences that consumers are accustomed to from animal meat. The present invention provides such and related food products, as well as processes for their production.

### SUMMARY

Disclosed herein are plant-based meat compositions comprising between about 1 wt % to about 50% wt % of an encapsulated formulation and one or more plant-based protein. The encapsulated formulation may include an unsaturated fat and one or more glucose-based polymer or an unsaturated fat and a protein matrix. The amount of unsaturated fat in the encapsulated formulation may be about 1 wt % to about 75 wt %. In some embodiments, the amount of unsaturated fat in the encapsulated formulation is about 30 wt % to about 75 wt %. The amount of total unsaturated fat in the plant-based meat composition is about 0.5 wt % to about 40 wt %. In some embodiments, the amount of the total unsaturated fat in the plant-based composition is about 0.5 wt % to about 15 wt %. The plant-based protein may be derived from one or more non-animal sources.

In some embodiments, the plant-based meat composition further includes a vegetable protein extrudate, a fat, a color, a flavor, one or more texturants, or combinations thereof.

In some embodiments, the plant-based meat composition further includes a high moisture meat analogue, wherein the high moisture meat analogue comprises one or more protein co-extruded with one or more macro and/or micronutrients and one or more additives.

In some embodiments, the one or more additives include a fat, a color, a flavor, one or more texturants, or combinations thereof.

In some embodiments, the unsaturated fat comprises a vegetable oil.

In some embodiments, the unsaturated fat comprises olive oil, peanut oil, canola oil, sunflower oil, palm oil, safflower oil, avocado oil, soybean oil, borage oil, evening primrose oil, safflower oil, flaxseed oil, wheat germ oil, grape seed oil, vitamin A, vitamin D, vitamin E, tocopherols, tocotrienols, vitamin K, beta-carotene, or combinations thereof.

In some embodiments, the amount of water in the encapsulated formulation is about less than 6 wt %.

In some embodiments, the density of the encapsulated formulation is about 0.3 g/cc to about 0.7 g/cc.

In some embodiments, the glucose-based polymer comprises starch, cellulose, or combinations thereof.

In some embodiments, the protein matrix comprises soy, pea, acacia, fava bean, lentils, chickpeas, beans, quinoa, spinach, or combinations thereof.

The amount of the one or more glucose-based polymer or a protein matrix in the encapsulated formulation is between about 20 wt % to about 70 wt %. In some embodiments, the amount of the one or more glucose-based polymer or a protein matrix in the encapsulated formulation is between about 25 wt % to about 50 wt %. The amount of the one of the one or more glucose-based polymer or a protein matrix in the plant-based meat composition is between about 0.1 wt % to about 28 wt %. In some embodiments, the one or more glucose-based polymer or a protein matrix in the plant-based meat composition is between about 0.1 wt % to about 28 wt %.

In some embodiments, the one or more glucose-based polymer is a combination of modified food starch based on waxy maize and maltodextrin.

In some embodiments, the unsaturated fat is encapsulated within the one or more glucose-based polymer or the protein matrix.

In some embodiments, the unsaturated fat is coated or partially coated with the one or more glucose-based polymer or the protein matrix.

In some embodiments, the plant-based meat composition includes about 0 wt % to about 30 wt % of saturated fat. In some embodiments, the plant-based meat composition includes about 5 wt % to about 10 wt % of saturated fat.

In some embodiments, the plant-based meat composition comprises less than 15.0 g, less than 14.5 g, less than 14.0 g, less than 13.5 g, less than 13.0 g, less than 12.5 g, less than 12.0 g, less than 11.5 g, less than 11.0 g, less than 10.5 g, less than 10.0 g, less than 9.5 g, less than 10.0 g, less than 9.5 g, less than 9.0 g, less than 8.5 g, less than 8.0 g, less than 7.5 g, less than 7.0 g, less than 6.5 g, less than 6.0 g, less than 5.5 g, less than 5.0 g, less than 4.5 g, less than 4.0 g, less than 3.5 g, less than 3.0 g, less than 2.5 g, less than 2.0 g, less than 1.5 g, less than 1.0 g, less than 0.5 g, less than 0.1 g, or 0 g of saturated fat per serving.

In some embodiments, the one or more non-animal sources comprises plant-based protein. In some embodiments, the plant-based protein comprises soy, pea, fava bean, lentils, chickpeas, beans, quinoa, seaweed, algae, or combinations thereof.

The amount of the plant-based protein in the composition is about 10 wt % to about 35 wt %. In some embodiments, the percent of the plant-based protein in the composition is about 13 wt % to about 35 wt %, water is about 25 wt % to about 65 wt %, and the encapsulated formulation is about 2.5 wt % to about 4.5 wt %. In some embodiments, the total unsaturated fat is about 0.5 wt % to about 15 wt %.

In some embodiments, the one or more plant-based protein comprise a food product that is not derived from an animal but has structure, texture, and/or properties comparable to those of animal meat.

In some embodiments, the plant-based meat composition includes organoleptic characteristics of a meat-based patty.

In some embodiments, wherein the plant-based meat composition is in the shape of a burger patty, a sausage, a pepperoni, a bacon, or a combination thereof.

In some embodiments, the composition is preserved at room temperature at 20° to 22° C.

In some embodiments, the composition is preserved upon refrigeration at 0° to 4° C.

In some embodiments, the composition is preserved upon freezing at −18° to −20° C.

In some embodiments, the processed meat-like product is cooked or re-heated prior to consumption.

In another aspect, the present disclosure is directed to a method of making a plant-based meat composition. The method includes incorporating a composition comprising an unsaturated fat and one or more glucose-based polymer or a protein matrix into a meat-like product.

### BRIEF DESCRIPTION OF THE FIGURES

FIG. 1 is pictorial representation of a process of forming an encapsulated formulation, in accordance with a representative embodiment of the present invention.

FIGS. 2A-2Q are pictorial images of various steps in the method of making a plant-based meat patty, in accordance with a representative embodiment of the present invention.

FIG. 3 is an exemplary scale used by panelists to rank their preferences in an illustrative embodiment, in accordance with a representative embodiment of the present invention.

FIG. 4 is bar graph showing the consumer acceptance score of burgers made from soy protein meat analogues and different fat compositions, in accordance with representative embodiments of the present invention.

FIG. 5 is a bar graph showing the effect of time and storage on overall acceptable of burgers made from soy protein meat analogues and different encapsulated formulations, in accordance with representative embodiments of the present invention.

### DETAILED DESCRIPTION

The following description of the embodiments of the invention is not intended to limit the invention to these embodiments but rather to enable a person skilled in the art to make and use this invention.

One aspect of the disclosure provides herein plant-based meat compositions that comprise an encapsulated formulation and one or more plant-based protein. In some embodiments, the encapsulated formulation may include an unsaturated fat. In some embodiments, the encapsulated formulation may include one or more glucose-based polymer or a protein matrix. In some embodiments, the encapsulated formulation may include an unsaturated fat and one or more glucose-based polymer or a protein matrix.

Another aspect of the disclosure provides a method of making a plant-based meat composition. The method may include incorporating an encapsulated formulation comprising an unsaturated fat and one or more glucose-based polymer or a protein matrix into a meat-like product.

Yet another aspect of the disclosure provides a processed meat-like product and a process of making the processed meat-like product comprising the plant-based meat compositions.

### Definitions

The terms “a” and “an” and “the” and similar referents as used herein refer to both the singular and the plural, unless otherwise indicated herein or clearly contradicted by context.

The term “about” as used herein refers to greater or lesser than the value or range of values stated by 1/10 of the stated values, but is not intended to limit any value or range of values to only this broader definition. For instance, a value of “about 30%” means a value of between 27% and 33%. Each value or range of values preceded by the term “about” is also intended to encompass the embodiment of the stated absolute value or range of values.

The term “animal meat” as used herein refers to flesh derived from skeletal muscle or from other organs (e.g., kidney, heart, liver, gallbladder, intestine, stomach, bone marrow, brain, thymus, lung, tongue), or parts thereof, derived from an animal. The animal meat can be dark or white meat. Suitable animals from which the animal meat can be derived include but are not limited to cattle, lamb, mutton, horse, poultry (e.g., chicken, duck, goose, turkey), fowl (any bird species, pigeon, dove, grouse, partridge, ostrich, emu, pheasant, quail), fresh or salt water fish (e.g., catfish, tuna, spearfish, shark, halibut, sturgeon, salmon, bass, muskie, pike, bowfin, gar, eel, paddlefish, bream, carp, trout, walleye, snakehead, crap-pie, sister, mussel, scallop, abalone, squid, octopus, sea urchin, cuttlefish, tunicate), crustacean (e.g., crab, lobster, shrimp, barnacle), game animals (e.g., deer, fox, wild pig, elk, moose, reindeer, caribou, antelope, zebra, squirrel, marmot, rabbit, bear, beaver, muskrat, opossum, raccoon, armadillo, porcupine, bison, buffalo, boar, lynx, bobcat, bat), reptiles (e.g., snakes, turtles, lizards, alligators, crocodiles), any insect or other arthropod, rodent (nutria, guinea pig, rat, mice, vole, groundhog, capybara), kangaroo, whale, and seal. The term refers to ground, chopped, shredded, or otherwise processed animal meat. The term encompasses both uncooked, cooking, and cooked animal meat unless otherwise indicated herein or clearly contradicted by context.

The term “dough” as used herein refers to a blend of dry ingredients (“dry mix”; e.g., proteins, carbohydrates, and lipids including encapsulated formulations) and liquid ingredients (“liquid mix”; e.g., water or juice [i.e., liquid based extract from a non-animal source such as a plant or any part of a plant]) from which a plant-based protein is produced through the application of mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymalic activity (e.g., crosslinking activity), chemical reagents (e.g., pH and/or ionic strength adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous structure (e.g., by rapid temperature and/or pressure change, rapid dehydration, chemical fixation, redox).

The term “emulsion” as used herein refers to a mixture of immiscible liquids in which one or more liquids (“dispersed phase(s)”) are dispersed as fine droplets in another liquid (“continuous phase”).

The term “emulsifier” as used herein refers to a molecule that concentrates at the interface between the phases of an emulsion and reduces the interfacial tension between the phases and thus stabilizes the emulsion. Nonionic emulsifiers that can stabilize oil-in-water or water-in-oil emulsions can be characterized by the Hydrophilic Lipophilic Balance (HLB), which indicates the solubility of the emulsifier. An emulsifier with a high HLB is more soluble in water and promotes oil-in-water emulsions as provided herein. An emulsifier with a low HLB is more soluble in oil and promotes water-in-oil emulsions as provided herein.

The term “gel” as used herein refers to a collection of solid polymer networks dispersed within a liquid that yields a material with properties ranging from a viscous liquid to loose solid.

The term “meat-like” as used herein refers to resemblance to animal meat. The term “meat-like food product” as used herein refers to a food product that is not derived from an animal but has structure, texture, and/or other properties comparable to those of animal meal. The term refers to uncooked, cooking, and cooked meat-like food product unless otherwise indicated herein or clearly contradicted by context.

The term “plant-based protein” as used herein refers to a product comprising protein fiber networks and/or aligned protein fibers that produce meat-like textures. It can be obtained from a dough after application of mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous and/or aligned structure (e.g., by rapid temperature and/or pressure change, rapid dehydration, chemical fixation, redox), and optional post-processing after the fibrous and/or aligned structure is generated and fixed (e.g., hydrating, marinating, drying, coloring). Methods for determining the degree of protein fiber network formation and/or protein fiber alignment are known in the art and include visual determination based upon photographs and micrographic images, as exemplified in U.S. Utility application Ser. No. 14/687,803 filed Apr. 15, 2015. In some embodiments, at least about 55%, at least about 65%, at least about 75%, at least about 85%, or at least about 95% of the protein fibers are substantially aligned. Protein fiber networks and/or protein fiber alignments may impart cohesion and firmness whereas open spaces in the protein fiber networks and/or protein fiber alignments may tenderize the plant-based protein and provide pockets for capturing water, carbohydrates, salts, lipids, flavorings, and other materials that are slowly released during chewing to lubricate the shearing process and to impart other meat-like sensory characteristics.

The term “preserved” as used herein may refer to the nutritional value, color, texture, taste, and flavor of the product being consistent over a specified period of time (e.g., at least 1 week, 2 weeks, 3 weeks, 4 weeks, 1 month, 2 months, 3 months, 4 months, 5 months, 6 months, 9 months, 12 months, and/or 18 months). The term “preserved” may also refer to a food composition or plant-based meat composition having 5% or less, 4% or less, 3% or less, 2% or less, 1% or less, or 0.5% or less of degradants forming over a specified period of time (e.g., at least 1 week, 2 weeks, 3 weeks, 4 weeks, 1 month, 2 months, 3 months, 4 months, 5 months, 6 months, 9 months, 12 months, and/or 18 months). The term “preserved” may also refer to a food composition or plant-based meat composition having 5% or less, 4% or less, 3% or less, 2% or less, 1% or less, or 0.5% or less change in protein content or fat content (e.g., at least 1 week, 2 weeks, 3 weeks, 4 weeks, 1 month, 2 months, 3 months, 4 months, 5 months, 6 months, 9 months, 12 months, and/or 18 months).

### Plant-Based Meat Compositions

In some embodiments, the plant-based meat composition may include an encapsulated formulation comprising an unsaturated fat and one or more glucose-based polymer or a protein matrix, and one or more plant-based protein.

In some embodiments, the plant-based meat composition may include a vegetable protein extrudate. In other embodiments, the plant-based meat composition may include additional fat. In some embodiments, the plant-based meat composition may include a color. In other embodiments, the plant-based meat composition may include a flavor. In some embodiments, the plant-based meat composition may include one or more texturants. In other embodiments, the plant-based meat composition may include a vegetable protein extrudate, additional fat, a color, a flavor, one or more texturants, or combinations thereof.

In some embodiments, the plant-based meat composition may further include a high moisture meat analogue. The high moisture meat analogue may comprise one or more protein co-extruded with one or more macro and/or micronutrients and one or more additives. In some embodiments, the one or more additives may include a fat, a color, a flavor, one or more texturants, or combinations thereof.

In some embodiments, the plant-based meat composition may include from about 1 wt % to about 50 wt % of an encapsulated formulation comprising an unsaturated fat and one or more glucose-based polymer or a protein matrix. For example, the encapsulated formulation may range from about 2 wt % to about 49 wt %, about 3 wt % to about 48 wt %, about 4 wt % to about 47 wt %, about 5 wt % to about 46 wt %, about 6 wt % to about 45 wt %, about 7 wt % to about 44 wt %, about 8 wt % to about 43 wt %, about 9 wt % to about 42 wt %, about 10 wt % to about 41 wt %, about 11 wt % to about 40 wt %, about 12 wt % to about 39 wt %, about 13 wt % to about 38 wt %, about 14 wt % to about 37 wt %, about 15 wt % to about 36 wt %, about 16 wt % to about 35 wt %, about 17 wt % to about 34 wt %, about 18 wt % to about 33 wt %, about 19 wt % to about 32 wt %, about 20 wt % to about 31 wt %, about 21 wt % to about 30 wt %, about 22 wt % to about 29 wt %, about 23 wt % to about 28 wt %, about 24 wt % to about 27 wt %, or about 25 wt % to about 26 wt %. In one embodiment, the plant-based meat composition may include from about 1 wt % to about 30 wt % of an encapsulated formulation.

In some embodiment, the plant-based meat composition may include from about 0.5 wt % to about 40 wt % of total unsaturated fat. For example, the total unsaturated fat may range from about 0.6 wt % to about 39 wt %, about 0.7 wt % to about 38 wt %, about 0.8 wt % to about 37 wt %, about 0.9 wt % to about 36 wt %, about 1 wt % to about 35 wt %, about 2 wt % to about 34 wt %, about 3 wt % to about 33 wt %, about 4 wt % to about 32 wt %, about 5 wt % to about 31 wt %, about 6 wt % to about 30 wt %, about 7 wt % to about 29 wt %, about 8 wt % to about 28 wt %, about 9 wt % to about 27 wt %, about 10 wt % to about 26 wt %, about 11 wt % to about 25 wt %, about 12 wt % to about 24 wt %, about 13 wt % to about 23 wt %, about 14 wt % to about 22 wt %, about 15 wt % to about 21 wt %, about 16 wt % to about 20 wt %, or about 17 wt % to about 19 wt %. In one embodiment, the plant-based meat composition may include from about 0.5 wt % to about 15 wt % of an unsaturated fat.

In some embodiments, the unsaturated fat may include a vegetable oil. Examples of suitable unsaturated fats include but are not limited to olive oil, peanut oil, canola oil, sunflower oil, palm oil, safflower oil, avocado oil, soybean oil, borage oil, evening primrose oil, safflower oil, flaxseed oil, wheat germ oil, grape seed oil, vitamin A, vitamin D, vitamin E, tocopherols, tocotrienols, vitamin K, beta-carotene, or combinations thereof.

In some embodiment, the plant-based meat composition may include from about 0.1 wt % to about 28 wt % of one or more glucose-based polymer or protein matrix. For example, the one or more glucose-based polymer or protein matrix may range from about 0.2 wt % to about 27 wt %, about 0.3 wt % to about 26 wt %, about 0.4 wt % to about 25 wt %, about 0.5 wt % to about 24 wt %, about 0.6 wt % to about 23 wt %, about 0.7 wt % to about 22 wt %, about 0.8 wt % to about 21 wt %, about 0.9 wt % to about 20 wt %, about 1.0 wt % to about 19 wt %, about 2 wt % to about 18 wt %, 3 wt % to about 17 wt %, about 4 wt % to about 16 wt %, about 5 wt % to about 15 wt %, about 6 wt % to about 14 wt %, about 7 wt % to about 13 wt %, about 8 wt % to about 12 wt %, or about 9 wt % to about 11 wt %. In one embodiment, the plant-based meat composition may include from about 0.5 wt % to about 15 wt % of one or more glucose-based polymer or protein matrix.

In some embodiments, the plant-based meat composition may include one or more plant-based protein. The plant-based protein may be derived from one or more non-animal sources. In some embodiments, the one or more non-animal sources may include a plant-based protein. Examples of plant-based protein include but are not limited to soy, pea, fava bean, lentils, chickpeas, beans, quinoa, seaweed, algae, or combinations thereof. In some embodiments, the one or more plant-based protein product may include a food product that is not derived from an animal. The one or more plant-based protein may have a structure, texture, and/or properties comparable to those of animal meat.

In some embodiments, the plant-based protein may be soy protein. The amount of soy protein in the plant-based meat composition may range from about 10 wt % to about 35 wt %. For example, the amount of soy protein may be about 11 wt % to about 34 wt %, about 12 wt % to about 33 wt %, about 13 wt % to about 32 wt %, about 14 wt % to about 31 wt %, about 15 wt % to about 30 wt %, about 16 wt % to about 29 wt %, about 17 wt % to about 28 wt %, about 18 wt % to about 27 wt %, about 19 wt % to about 26 wt %, about 20 wt % to about 25 wt %, about 21 wt % to about 24 wt %, or about 22 wt % to about 23 wt %.

In some embodiments, the plant-based protein may be pea protein. The amount of pea protein in the plant-based meat composition may range from about 10 wt % to about 35 wt %. For example, the amount of pea protein may be from about 11 wt % to about 34 wt %, about 12 wt % to about 33 wt %, about 13 wt % to about 32 wt %, about 14 wt % to about 31 wt %, about 15 wt % to about 30 wt %, about 16 wt % to about 29 wt %, about 17 wt % to about 28 wt %, about 18 wt % to about 27 wt %, about 19 wt % to about 26 wt %, about 20 wt % to about 25 wt %, or about 22 wt % to about 24 wt %.

In some embodiments, the plant-based meat composition may include about 3 wt % to about 60 wt %. Suitable sources of water include but are not limited to distilled water, tap water, mineral water, cold water, ice-cold water, or room temperature water. For example, the amount of water in the plant-based meat composition may be from about 4 wt % to about 59 wt %, about 5 wt % to about 58 wt %, about 6 wt % to about 57 wt %, about 7 wt % to about 56 wt %, about 8 wt % to about 55 wt %, about 9 wt % to about 54 wt %, about 10 wt % to about 53 wt %, about 11 wt % to about 52 wt %, about 12 wt % to about 51 wt %, about 13 wt % to about 50 wt %, about 14 wt % to about 49 wt %, about 15 wt % to about 48 wt %, about 16 wt % to about 47 wt %, about 17 wt % to about 46 wt %, about 18 wt % to about 45 wt %, about 19 wt % to about 44 wt %, about 20 wt % to about 43 wt %, about 21 wt % to about 42 wt %, about 22 wt % to about 41 wt %, about 23 wt % to about 40 wt %, 24 wt % to about 39 wt %, about 25 wt % to about 38 wt %, about 26 wt % to about 37 wt %, about 27 wt % to about 36 wt %, about 28 wt % to about 35 wt %, about 29 wt % to about 34 wt %, about 30 wt % to about 33 wt %, or about 31 wt % to about 32 wt %.

In some embodiments, the amount of saturated fat in the plant-based meat composition may range from about 0 wt % to about 30 wt %. For example, the amount of saturated fat may be from about 1 wt % to about 29 wt %, about 2 wt % to about 28 wt %, about 3 wt % to about 27 wt %, about 4 wt % to about 26 wt %, about 5 wt % to about 25 wt %, about 6 wt % to about 24 wt %, about 7 wt % to about 23 wt %, about 8 wt % to about 22 wt %, about 9 wt % to about 21 wt %, about 10 wt % to about 20 wt %, about 11 wt % to about 19 wt %, about 12 wt % to about 18 wt %, about 13 wt % to about 17 wt %, or about 14 wt % to about 16 wt % In one embodiment, the plant-based meat composition may include from about 5 wt % to about 10 wt % of an saturated fat.

In some embodiments, the plant-based meat composition may reduce the saturated fat in a plant-based meat composition product by about 5 wt % to about 100 wt %. For example, the saturated fat may be reduced by about 5.5 wt %, about 6.0 wt %, about 6.5 wt %, about 7.0 wt %, about 7.5 wt %, about 8.0 wt %, 8.5 wt %, about 9.0 wt %, about 9.5 wt %, about 10.0 wt %, about 10.5 wt %, about 11.0 wt %, about 11.5 wt %, about 12.0 wt %, about 12.5 wt %, about 13.0 wt %, about 13.5 wt %, about 14.0 wt %, about 14.5 wt %, about 15.0 wt %, about 15.5 wt %, about 16.0 wt %, about 16.5 wt %, about 17.0 wt %, about 17.5 wt %, about 18.0 wt %, about 18.5 wt %, about 19.0 wt %, about 19.5 wt %, about 20.0 wt %, about 20.5 wt %, about 21.0 wt %, about 21.5 wt %, about 22.0 wt %, about 22.5 wt %, about 23.0 wt %, about 23.5 wt %, about 24.0 wt %, about 24.5 wt %, about 25.0 wt %, about 25.5 wt %, about 26.0 wt %, about 26.5 wt %, about 27.0 wt %, about 27.5 wt %, about 28.0 wt %, about 28.5 wt %, about 29.0 wt %, about 29.5 wt %, about 30.0 wt %, about 30.5 wt %, about 31.0 wt %, about 31.5 wt %, about 32.0 wt %, about 32.5 wt %, about 33.0 wt %, about 33.5 wt %, about 34.0 wt %, about 34.5 wt %, about 35.0 wt %, about 35.5 wt %, about 36.0 wt %, about 36.5 wt %, about 37.0 wt %, about 37.5 wt %, about 38.0 wt %, about 38.5 wt %, about 39.0 wt %, about 39.5 wt %, about 40.0 wt %, about 40.5 wt %, about 41.0 wt %, about 41.5 wt %, about 42.0 wt %, about 42.5 wt %, about 43.0 wt %, about 43.5 wt %, about 44.0 wt %, about 44.5 wt %, about 45.0 wt %, about 45.5 wt %, about 46.0 wt %, about 46.5 wt %, about 47.0 wt %, about 47.5 wt %, about 48.0 wt %, about 48.5 wt %, about 49.0 wt %, about 49.5 wt %, about 50.0 wt %, about 50.5 wt %, about 51.0 wt %, about 51.5 wt %, about 52.0 wt %, about 52.5 wt %, about 53.0 wt %, about 53.5 wt %, about 54.0 wt %, about 54.5 wt %, about 55.0 wt %, about 55.5 wt %, about 56.0 wt %, about 56.5 wt %, about 57.0 wt %, about 57.5 wt %, about 58.0 wt %, about 58.5 wt %, about 59.0 wt %, about 59.5 wt %, about 60.0 wt %, about 60.5 wt %, about 61.0 wt %, about 61.5 wt %, about 62.0 wt %, about 62.5 wt %, about 63.0 wt %, about 63.5 wt %, about 64.0 wt %, about 64.5 wt %, about 65.0 wt %, about 65.5 wt %, about 66.0 wt %, about 66.5 wt %, about 67.0 wt %, about 67.5 wt %, about 68.0 wt %, about 68.5 wt %, about 69.0 wt %, about 69.5 wt %, about 70.0 wt %, about 70.5 wt %, about 71.0 wt %, about 71.5 wt %, about 72.0 wt %, about 72.5 wt %, about 73.0 wt %, about 73.5 wt %, about 74.0 wt %, about 74.5 wt %, about 75.0 wt %, about 75.5 wt %, about 76.0 wt %, about 76.5 wt %, about 77.0 wt %, about 77.5 wt %, about 78.0 wt %, about 78.5 wt %, about 79.0 wt %, about 79.5 wt %, about 80.0 wt %, about 80.5 wt %, about 81.0 wt %, about 81.5 wt %, about 82.0 wt %, about 82.5 wt %, about 83.0 wt %, about 83.5 wt %, about 84.0 wt %, about 84.5 wt %, about 85.0 wt %, about 85.5 wt %, about 86.0 wt %, about 86.5 wt %, about 87.0 wt %, about 87.5 wt %, about 88.0 wt %, about 88.5 wt %, about 89.0 wt %, about 89.5 wt %, about 90.0 wt %, about 90.5 wt %, about 91.0 wt %, about 91.5 wt %, about 92.0 wt %, about 92.5 wt %, about 93.0 wt %, about 93.5 wt %, about 94.0 wt %, about 94.5 wt %, about 95.0 wt %, about 95.5 wt %, about 96.0 wt %, about 96.5 wt %, about 97.0 wt %, about 97.5 wt %, about 98.0 wt %, about 98.5 wt %, about 99.0 wt %, about 99.5 wt % or about 100 wt %.

In some embodiments, the plant-based meat composition may include an organoleptic characteristic of a meat-based patty.

### Encapsulated Formulation

The encapsulated formulation includes an unsaturated fat and one or more glucose-based polymer or a protein matrix. The unsaturated fat may be liquid oil within a starch matrix. The liquid oil with a starch matrix may be spray dried forming spray dried lipid powder. Spray dried lipid powder may be used herewith interchangeably with an encapsulated formulation. In some embodiments, the encapsulated formulation may be a spray dried lipid powder. The unsaturated fat may be in the form of spray dried lipid powders. Disclosed herein is the use of spray dried lipid powders that may include an encapsulated liquid oil within a starch or a protein matrix that mimics the functionality of a saturated fat with regards to processing and organoleptic characteristics in a food application.

Oils are liquid at room temperature due to the higher amount of unsaturated fatty acids that may have a lower melting point, whereas certain fats are solid or semi-solid at room temperature due to the higher amount of saturated fatty acids that have a higher melt point. Unsaturated lipids may be better nutritionally so use of spray dried lipid powders for this purpose can create nutritionally superior products without compromising finished food quality. However, saturated fats may have higher melting temperatures than liquid oil so this may create a different organoleptic characteristic in applications.

The glucose-based polymer or protein matrix may prevent the liquid oil from leaching out in the application, mimicking the functionality of a solid fat even at high temperatures creating the same mouthfeel as saturated fats. Furthermore, while mixing and forming, liquid oils may not provide the same binding effect that spray dried powders provide creating a more slippery, thinner dough that is difficult to form with liquid oils. Using a powder system further creates a more uniform well distributed oil droplets with a more consistent droplet size compared to adding the unencapsulated oil.

In another aspect, provided herein are encapsulated formulations made by spray drying technology. Such spray dried encapsulated formulations comprise an unsaturated fat in order to reduce saturated fat in plant-based meat compositions and therefore be nutritionally superior, without compromising the mouthfeel, texture and sensory scores associated with a saturated fat.

Spray dried encapsulated formulations comprising unsaturated fat at up to about 50%, about 55%, about 60%, about 65%, about 70%, about 75%, about 80%, about 85%, about 90%, about 95%, or about 100% replacement level of saturated fat may provide the same preference scores in plant-based meat patties compared to full fat control. Spray dried encapsulated formulations comprising unsaturated fat may provide better textural liking in plant-based patties compared to the unencapsulated liquid unsaturated oil. Spray dried encapsulated formulations comprising unsaturated fat also may provide firmer dough while handling and forming of patties compared to unencapsulated liquid unsaturated oil that was tested. Spray dried encapsulated formulations comprising unsaturated fat may encapsulate the liquid unsaturated oil and may mimic the functionality and structure of a solid fat to create the same mouthfeel and processing advantages that an unencapsulated liquid unsaturated oil cannot in certain food applications.

In some embodiments, the encapsulated formulation may comprise from about 20 wt % to about 70 wt % of the one or more glucose-based polymer or a protein matrix. For example, the one or more glucose-based polymer or a protein matrix may range from about 21 wt % to about 69 wt %, about 22 wt % to about 68 wt %, about 23 wt % to about 67 wt %, about 24 wt % to about 66 wt %, about 25 wt % to about 65 wt %, about 26 wt % to about 64 wt %, about 27 wt % to about 63 wt %, about 28 wt % to about 62 wt %, about 29 wt % to about 61 wt %, about 30 wt % to about 60 wt %, about 31 wt % to about 59 wt %, about 32 wt % to about 58 wt %, about 33 wt % to about 57 wt %, about 34 wt % to about 56 wt %, about 35 wt % to about 55 wt %, about 36 wt % to about 54 wt %, about 37 wt % to about 53 wt %, about 38 wt % to about 52 wt %, about 39 wt % to about 51 wt %, about 40 wt % to about 50 wt %, about 41 wt % to about 49 wt %, about 42 wt % to about 48 wt %, about 43 wt % to about 47 wt %, or about 44 wt % to about 46 wt %. In one embodiment, the encapsulated formulation and/or the plant-based meat composition may include from about 20 wt % to about 50 wt % of the one or more glucose-based polymer or a protein matrix.

In some embodiments, the encapsulated formulation may comprise from about 1 wt % to about 75 wt % of an unsaturated fat. For example, the unsaturated fat in the encapsulated formulation may range from about 2 wt % to about 74 wt %, about 3 wt % to about 73 wt %, about 4 wt % to about 72 wt %, about 5 wt % to about 71 wt %, about 6 wt % to about 70 wt %, about 7 wt % to about 69 wt %, about 8 wt % to about 68 wt %, about 9 wt % to about 67 wt %, about 10 wt % to about 66 wt %, about 11 wt % to about 65 wt %, about 12 wt % to about 64 wt %, about 13 wt % to about 63 wt %, about 14 wt % to about 62 wt %, about 15 wt % to about 61 wt %, about 16 wt % to about 60 wt %, about 17 wt % to about 59 wt %, about 18 wt % to about 58 wt %, about 19 wt % to about 57 wt %, about 20 wt % to about 56 wt %, about 21 wt % to about 55 wt %, about 22 wt % to about 54 wt %, about 23 wt % to about 53 wt %, about 24 wt % to about 52 wt %, about 25 wt % to about 51 wt %, about 26 wt % to about 50 wt %, about 27 wt % to about 49 wt %, about 28 wt % to about 48 wt %, about 29 wt % to about 47 wt %, about 30 wt % to about 46 wt %, about 31 wt % to about 45 wt %, about 32 wt % to about 44 wt %, about 33 wt % to about 43 wt %, about 34 wt % to about 42 wt %, about 35 wt % to about 41 wt %, about 36 wt % to about 40 wt %, or about 37 wt % to about 39 wt %. In one embodiment, the encapsulated formulation may include from about 30 wt % to about 75 wt % of an unsaturated fat.

In some embodiments, the unsaturated fat in the encapsulated formulation may be sunflower oil. The amount of sunflower oil may range from about 30 wt % to about 75 wt % in the encapsulated formulation. For example, the sunflower oil may range from about 31 wt % to about 74 wt %, about 32 wt % to about 73 wt %, about 33 wt % to about 72 wt %, about 34 wt % to about 71 wt %, about 35 wt % to about 70 wt %, about 36 wt % to about 69 wt %, about 37 wt % to about 68 wt %, about 38 wt % to about 67 wt %, about 39 wt % to about 66 wt %, about 40 wt % to about 65 wt %, about 41 wt % to about 64 wt %, about 42 wt % to about 63 wt %, about 43 wt % to about 62 wt %, about 44 wt % to about 61 wt %, about 45 wt % to about 60 wt %, about 46 wt % to about 59 wt %, about 47 wt % to about 58 wt %, about 48 wt % to about 57 wt %, about 49 wt % to about 56 wt %, about 50 wt % to about 55 wt %, about 51 wt % to about 54 wt %, or about 52 wt % to about 53 wt %.

In some embodiments, the encapsulated formulation may include about less than 6 wt % of water. Suitable sources of water include but are not limited to distilled water, tap water, mineral water, cold water, ice-cold water, or room temperature water. For example, the amount of water in the encapsulated formulation may be from about 0 wt % to about 5.9 wt %, about 0.1 wt % to about 5.8 wt %, about 0.2 wt % to about 5.7 wt %, about 0.3 wt % to about 5.6 wt %, about 0.4 wt % to about 5.5 wt %, about 0.5 wt % to about 5.4 wt %, about 0.6 wt % to about 5.3 wt %, about 0.7 wt % to about 5.2 wt %, about 0.8 wt % to about 5.1 wt %, about 0.9 wt % to about 5.0 wt %, about 1.0 wt % to about 4.9 wt %, about 1.1 wt % to about 4.8 wt %, 1.2 wt % to about 4.7 wt %, about 1.3 wt % to about 4.6 wt %, about 1.4 wt % to about 4.5 wt %, about 1.5 wt % to about 4.4 wt %, about 1.6 wt % to about 4.3 wt %, about 1.7 wt % to about 4.2 wt %, about 1.8 wt % to about 4.1 wt %, about 1.9 wt % to about 4.0 wt %, about 2.0 wt % to about 3.9 wt %, about 2.1 wt % to about 3.8 wt %, 2.2 wt % to about 3.7 wt %, about 2.3 wt % to about 3.6 wt %, about 2.4 wt % to about 3.5 wt %, about 2.5 wt % to about 3.4 wt %, about 2.6 wt % to about 3.3 wt %, about 2.7 wt % to about 3.2 wt %, about 2.8 wt % to about 3.1 wt %, or about 2.9 wt % to about 3.0 wt %.

In some embodiments, the bulk density of the encapsulated formulation may be from about 0.1 g/cc to about 0.9 g/cc. For example, the density may range from about 0.2 g/cc to about 0.8 g/cc, about 0.3 g/cc to about 0.7 g/cc, or about 0.4 g/cc to about 0.6 g/cc. In one embodiment, the density may range from about 0.3 g/cc to about 0.7 g/cc.

In some embodiments, the encapsulated formulation may reduce the saturated fat in a plant-based meat composition by about 5 wt % to about 100 wt %. For example, the saturated fat may be reduced by about 5.5 wt %, about 6.0 wt %, about 6.5 wt %, about 7.0 wt %, about 7.5 wt %, about 8.0 wt %, 8.5 wt %, about 9.0 wt %, about 9.5 wt %, about 10.0 wt %, about 10.5 wt %, about 11.0 wt %, about 11.5 wt %, about 12.0 wt %, about 12.5 wt %, about 13.0 wt %, about 13.5 wt %, about 14.0 wt %, about 14.5 wt %, about 15.0 wt %, about 15.5 wt %, about 16.0 wt %, about 16.5 wt %, about 17.0 wt %, about 17.5 wt %, about 18.0 wt %, about 18.5 wt %, about 19.0 wt %, about 19.5 wt %, about 20.0 wt %, about 20.5 wt %, about 21.0 wt %, about 21.5 wt %, about 22.0 wt %, about 22.5 wt %, about 23.0 wt %, about 23.5 wt %, about 24.0 wt %, about 24.5 wt %, about 25.0 wt %, about 25.5 wt %, about 26.0 wt %, about 26.5 wt %, about 27.0 wt %, about 27.5 wt %, about 28.0 wt %, about 28.5 wt %, about 29.0 wt %, about 29.5 wt %, about 30.0 wt %, about 30.5 wt %, about 31.0 wt %, about 31.5 wt %, about 32.0 wt %, about 32.5 wt %, about 33.0 wt %, about 33.5 wt %, about 34.0 wt %, about 34.5 wt %, about 35.0 wt %, about 35.5 wt %, about 36.0 wt %, about 36.5 wt %, about 37.0 wt %, about 37.5 wt %, about 38.0 wt %, about 38.5 wt %, about 39.0 wt %, about 39.5 wt %, about 40.0 wt %, about 40.5 wt %, about 41.0 wt %, about 41.5 wt %, about 42.0 wt %, about 42.5 wt %, about 43.0 wt %, about 43.5 wt %, about 44.0 wt %, about 44.5 wt %, about 45.0 wt %, about 45.5 wt %, about 46.0 wt %, about 46.5 wt %, about 47.0 wt %, about 47.5 wt %, about 48.0 wt %, about 48.5 wt %, about 49.0 wt %, about 49.5 wt %, about 50.0 wt %, about 50.5 wt %, about 51.0 wt %, about 51.5 wt %, about 52.0 wt %, about 52.5 wt %, about 53.0 wt %, about 53.5 wt %, about 54.0 wt %, about 54.5 wt %, about 55.0 wt %, about 55.5 wt %, about 56.0 wt %, about 56.5 wt %, about 57.0 wt %, about 57.5 wt %, about 58.0 wt %, about 58.5 wt %, about 59.0 wt %, about 59.5 wt %, about 60.0 wt %, about 60.5 wt %, about 61.0 wt %, about 61.5 wt %, about 62.0 wt %, about 62.5 wt %, about 63.0 wt %, about 63.5 wt %, about 64.0 wt %, about 64.5 wt %, about 65.0 wt %, about 65.5 wt %, about 66.0 wt %, about 66.5 wt %, about 67.0 wt %, about 67.5 wt %, about 68.0 wt %, about 68.5 wt %, about 69.0 wt %, about 69.5 wt %, about 70.0 wt %, about 70.5 wt %, about 71.0 wt %, about 71.5 wt %, about 72.0 wt %, about 72.5 wt %, about 73.0 wt %, about 73.5 wt %, about 74.0 wt %, about 74.5 wt %, about 75.0 wt %, about 75.5 wt %, about 76.0 wt %, about 76.5 wt %, about 77.0 wt %, about 77.5 wt %, about 78.0 wt %, about 78.5 wt %, about 79.0 wt %, about 79.5 wt %, about 80.0 wt %, about 80.5 wt %, about 81.0 wt %, about 81.5 wt %, about 82.0 wt %, about 82.5 wt %, about 83.0 wt %, about 83.5 wt %, about 84.0 wt %, about 84.5 wt %, about 85.0 wt %, about 85.5 wt %, about 86.0 wt %, about 86.5 wt %, about 87.0 wt %, about 87.5 wt %, about 88.0 wt %, about 88.5 wt %, about 89.0 wt %, about 89.5 wt %, about 90.0 wt %, about 90.5 wt %, about 91.0 wt %, about 91.5 wt %, about 92.0 wt %, about 92.5 wt %, about 93.0 wt %, about 93.5 wt %, about 94.0 wt %, about 94.5 wt %, about 95.0 wt %, about 95.5 wt %, about 96.0 wt %, about 96.5 wt %, about 97.0 wt %, about 97.5 wt %, about 98.0 wt %, about 98.5 wt %, about 99.0 wt %, about 99.5 wt % or about 100 wt %.

In some embodiments, the encapsulated formulation may include an unsaturated fat. In some embodiments, the encapsulation formulation may include one or more glucose-based polymer. In other embodiments, the encapsulated formulation may include a protein matrix. In one embodiment, the encapsulated formulation may include an unsaturated fat and one or more glucose-based polymer. In another embodiment, the encapsulated formulation may include an unsaturated fat and a protein matrix. In another embodiment, the encapsulated formulation may include an unsaturated fat and one or more glucose-based polymer or a protein matrix. In some embodiments, the encapsulated formulation may include water.

In some embodiments, the unsaturated fat may include a vegetable oil. Examples of suitable unsaturated fats include but are not limited to olive oil, peanut oil, canola oil, sunflower oil, palm oil, safflower oil, avocado oil, soybean oil, borage oil, evening primrose oil, safflower oil, flaxseed oil, wheat germ oil, grape seed oil, vitamin A, vitamin D, vitamin E, tocopherols, tocotrienols, vitamin K, beta-carotene, or combinations thereof.

In some embodiments, the one or more glucose-based polymer matrix may include starch, cellulose, corn syrup, tapioca fiber, inulin, polydextrose, or combinations thereof. In some embodiments, the one or more glucose-based polymer matrix may be a combination of modified food starch based on waxy maize and maltodextrin. In some embodiments, the protein matrix may include pea protein, acacia, chickpea, soy, oat protein, oat solids, canola protein, barley rice protein, fava bean protein, or combinations thereof.

In some embodiments, the unsaturated fat may be encapsulated within the one or more glucose-based polymer matrix or the protein matrix. In some embodiments, the unsaturated fat may be coated or partially coated with the one or more glucose-based polymer matrix or the protein matrix.

In some embodiments, the encapsulated formulation may be a powder. In other embodiments, the encapsulated formulation may be a fine powder. In other embodiments, the encapsulated formulation may be a spray-dried powder.

### Processed Meat-Like Product

In some embodiments, the plant-based meat composition may be used to make a processed-meat like product. Examples of the processed-meat like product includes but is not limited to a burger patty, a sausage, a pepperoni, a bacon, or combinations thereof.

In some embodiments, the processed meat-like product may include about 13 wt % to about 35 wt % of plant-based protein, about 25 wt % to about 65 wt % of water, and about 2.5 wt % to about 4.5 wt % of the encapsulated formulation. In some embodiments, the processed meat-like product may include a total unsaturated fat of about 0.5 wt % to about 15 wt %. In some embodiments, the processed meat-like product may be preserved at room temperature. In some embodiments, the processed meat-like product may be preserved at upon refrigeration. In some embodiments, the processed meat-like product may be preserved upon freezing.

In some embodiments, the processed meat-like product may be cooked prior to consumption. In some embodiments, the processed meat-like product may be re-heated prior to consumption.

### Method of Making an Encapsulated Formulation

Spray drying technology may turn liquid oil or solid fat into a powder form where the lipid may be embedded in a starch or a protein matrix. This may create a stable suspension of finer lipid droplets that can be distributed more uniformly in finished application. The powder format may allow for easier use in applications where a liquid oil or solid fat may not create the same organoleptic functionality such as beverage mixes, ready-to-drink hot or cold beverages.

In some embodiments, any spray drying technology may be used to make the encapsulated formulation. Alternatively the encapsulated formulation may be prepared using any appropriate encapsulation techniques. Encapsulation techniques include but are not limited to extrusion, pan coating, emulsification, coacervation phase separation, solvent evaporation, coacervation, interfacial polymerization, or spray cooling.

In some embodiments, the encapsulated formulation may be made by preparing an oil/water emulsion. In some embodiments, the emulsion may be prepared by mixing the one or more glucose-based polymer matrix or a protein matrix with water to form a gel. Once the emulsion gel is formed, an unsaturated fat may be added to the gel and then mixed.

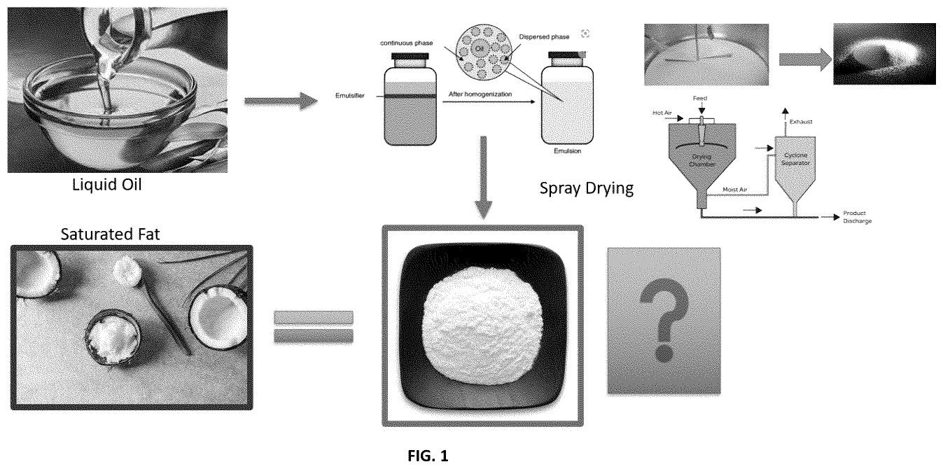

FIG. 1 shows the steps in the spray drying process to encapsulate a liquid oil into a glucose-based matrix according to one embodiment. FIG. 1 also shows that the resulting encapsulated formulation (spray dried lipid powder) containing unsaturated fat.

### Method of Making Plant-Based Meat Compositions

In some embodiments, the encapsulated formulation may be used to make plant-based meat composition (i.e., the plant-based meat composition comprises the encapsulated formulation). The method includes incorporating a composition comprising an unsaturated fat and one or more glucose-based polymer or protein matrix into a meat-like product, and optionally shaping the meat-like product (e.g., into a burger patty, a sausage, a pepperoni, a bacon, or combinations thereof).

In one embodiment, the method includes preparing an encapsulated formulation and then mixing water, food coloring, and a plant-based protein with the encapsulated formulation in order to create a plant-based meat composition. In another embodiment, the method includes additionally mixing flavoring, spices, water, food coloring, and a plant-based protein with the encapsulated formulation in order to create a plant-based meat composition.

As a person skilled in the art will recognize from the previous detailed description and from the figures and claims, modifications and changes may be made to the embodiments of the invention without departing from the scope of this invention as defined in the following claims.

### EXAMPLES

The following examples illustrate various non-limiting embodiments of the present disclosure.

### Example 1—Encapsulated formulations

Encapsulated formulations of Samples 1 and 2 were prepared using sunflower oil, food starch-modified, maltodextrin, anti-caking agent, water, and natural tocopherols. Encapsulated formulation of Sample 3 was prepared using sunflower oil, chickpea protein, tapioca fiber powder, silicon dioxide, and water. The encapsulated formulations in Samples 1 and 2 were prepared using emulsification and spray drying the sunflower oil with the maltodextrin and food starch-modified. Encapsulated formulation in Sample 3 was prepared using emulsification and spray drying the sunflower oil with the chickpea protein.

Table 1 shows an encapsulated formulations in Samples 1 through 3.

TABLE 1
Encapsulated formulations prepared.

| Sample | Component | Weight (g) |
|---|---|---|
| Sample 1 | Glucose-based polymers | 20.00-25.00 |
| | Unsaturated fat | 75 |
| | Sodium silicoaluminate | 1 |
| | Water | 1 |
| Sample 2 | Glucose-based polymers | 46-50 |
| | Unsaturated fat | 48-52 |
| | Tricalcium phosphate | 1-2 |
| | Water | 1-2 |
| Sample 3 | Glucose-based polymers and | 46-50 |
| | protein | |
| | Unsaturated fat | 48-52 |
| | Silicon dioxide | 2 |
| | Water | 0.3-0.5 |

### Example 2: Preparation of Patties

The details of method of making patties is provided below. Soy patties with encapsulated formulations (Samples 1-3) were prepared. Control soy patties with coconut oil (Control) and soy patties with unencapsulated liquid sunflower oil (Samples 4-6) were also prepared. All samples were sensory tested at an initial time, after 30 days, 90 days of storage, 180 days of storage, and after 330 days of storage.

The different encapsulation formulations used are listed in Table 2.

TABLE 2
Encapsulation Formulations.

| Sample Type | Fat | Components |
|---|---|---|
| Control | Coconut | Coconut oil |
| Formulation 1 | encapsulated | encapsulated sunflower oil |
| | sunflower oil powder | powder containing sunflower oil |
| | containing sunflower | (75%), food-starch modified, |
| | oil (75%) | maltodextrin, sodium silico |
| | | aluminate, natural tocopherols |
| Formulation 2 | encapsulated | encapsulated sunflower oil |
| | sunflower oil powder | powder containing sunflower oil |
| | containing sunflower | (50%), food-starch modified, |
| | oil (50%) | maltodextrin, tricalcium |
| | | phosphate, natural tocopherols, |
| | | and water |
| Formulation 3 | encapsulated | encapsulated sunflower oil |
| | sunflower oil powder | powder containing sunflower oil |
| | containing sunflower | (47-51%), chickpea protein |
| | oil (50%) | (60%), tapioca fiber powder, |
| | | silicon dioxide, and water |
| Formulation 4 | 75% sunflower oil | sunflower oil (75%), food-starch |
| | | modified, maltodextrin, natural |
| | | tocopherols |
| Formulation 5 | 50% sunflower oil | sunflower oil (50%), food-starch |
| | | modified, maltodextrin, natural |
| | | tocopherols, and water |
| Formulation 6 | 50% sunflower oil | sunflower oil (47-51%), |
| | | chickpea protein (60%), tapioca |
| | | fiber powder, and water |

A methylcellulose (MC) gel emulsion was used at about 5 wt % to about 30 wt % of the total plant-based patty, resulting from about 1 wt % to about 7 wt % MC gel emulsion, about 1 wt % to about 7 wt % canola oil, and about 14 wt % to about 20 wt % of water.

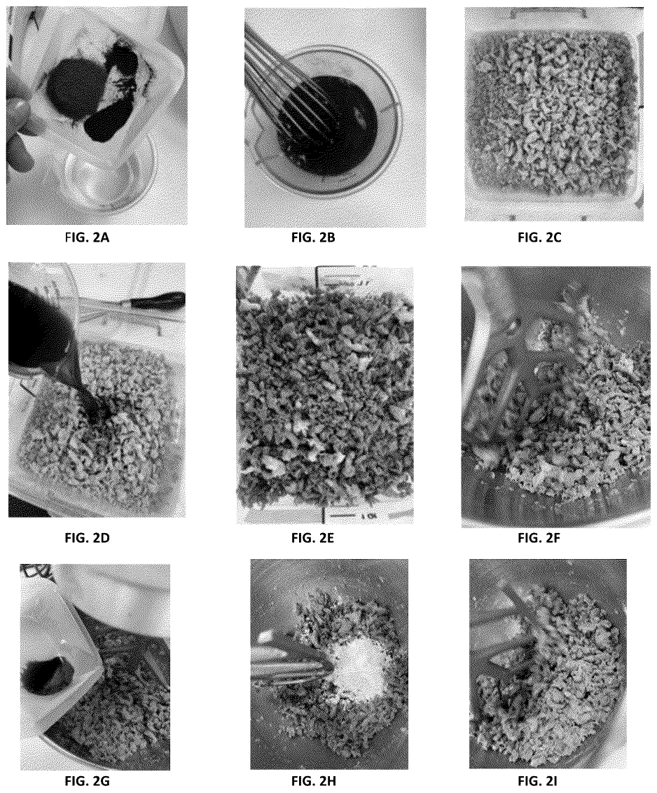

As shown in FIGS. 2A and 2B, food coloring was added to water and dissolved. As shown in FIG. 2C, texturized protein was weighed in a container. As shown in FIGS. 2D and 2E, the hydration water with fully dissolved food coloring was poured over the textured protein and mixed gently for better distribution of colored water into the protein. The solution was refrigerated to continue hydration for a minimum of 30 minutes or longer and then mixed as shown in FIG. 2F.

As shown in FIG. 2G, liquid flavoring was added to the hydrated mixture and then mixed. FIGS. 2H and 2I show that dry ingredients (protein isolate, modified starch and powdered flavor) were subsequently added and mixed until all ingredients were mixed well with the texturized protein.

Next, as shown in FIG. 2J, the MC gel emulsion made above was added to the texturized protein. In the control formulation, coconut oil in solid form was added. In Samples 1 to 3, the respective encapsulated formulations (i.e., Formulations 1 to 3) were added. In Samples 4 to 6, unencapsulated sunflower oil was added (i.e., Formulations 4 to 6). Canola oil was then added and mixed until all ingredients were well mixed in and the mixture was smooth and held together as shown in FIG. 2K.

Spices and salt were added to the mixture and mixed as shown in FIG. 2L followed by encapsulated lactic acid as shown in FIG. 2M. After the addition of the encapsulated lactic acid, the mixture was mixed again. Lastly, coconut oil flakes were added to the mixture and mixed forming a meaty dough mix (FIG. 2N and FIG. 2O).

The meaty dough mix was placed in a refrigerator for a minimum of 1 hour to overnight.

To make the patties, metal/molding rings were placed into a suitable tray that can help with better molding/shaping the patties. The meaty mix was molded into patties shape by hand and placed into the metal/molding rings to shape into patties (FIG. 2P). The rings were left in place to protect while vacuum packing. The filled tray was placed into vacuum bags and excess air was removed using a vacuum sealer. The bags were heat sealed and placed in a freezer. The molding metal ring was then removed, and the patties were re-sealed in bags and kept frozen.

Once thawed, the patties were baked in a microwave or in an oven. A digital thermometer was used to verify the internal temperature reached 165° F. FIG. 2Q is a pictorial image of the patties.

The ingredients in the soy patties formed, using the method described above, is shown in Tables 3 to 5. Pea patties were also formed using the method described above. The compositions of the pea patties were similar to the soy patties.

TABLE 3
Control - Soy Patties with Coconut Oil.

| Control Soy Patty | Formula (wt %) |
|---|---|
| Protein hydration water | 40.00 ± 15.00 |
| Texturized soy protein | 20.00 ± 12.00 |
| Water for MC emulsion gel | 16.00 ± 9.00 |
| Beef flavors | 4.50 ± 1.00 |
| Canola oil | 4.00 ± 3.00 |
| Coconut oil flakes | 3.50 ± 1.00 |
| Coconut oil (i.e., saturated fat) | 3.50 ± 1.00 |
| Soy protein isolate | 2.00 ± 1.00 |
| Starch | 1.00 ± 1.00 |
| Methylcellulose | 2.00 ± 1.00 |
| Salt | 1.00 ± 0.50 |
| Food coloring | 0.80 ± 0.40 |
| E Lactic Acid | 0.60 ± 0.40 |
| Yeast Extract | 0.80 ± 0.40 |
| Spices | 0.30 ± 0.30 |
| TOTAL | 100.00 |

TABLE 4
Samples 1, 2, and 3 - Soy Patties with Formulation 1, 2, or 3.

| Soy Patty | Formula (wt %) |
|---|---|
| Protein hydration water | 40.00 ± 15.00 |
| Texturized soy protein | 20.00 ± 12.00 |
| Water for MC emulsion gel | 16.00 ± 9.00 |
| Beef flavors | 4.50 ± 1.00 |
| Sunflower oil | 4.00 ± 3.00 |
| Formulation 1, 2, or 3 | 3.50 ± 1.00 |
| Coconut oil as flakes | 3.50 ± 1.00 |
| Soy protein isolate | 2.00 ± 1.00 |
| Starch | 1.00 ± 1.00 |
| Methylcellulose | 2.00 ± 1.00 |
| Salt | 1.00 ± 0.50 |
| Food coloring | 0.80 ± 0.40 |
| E Lactic Acid | 0.60 ± 0.40 |
| Yeast Extract | 0.80 ± 0.40 |
| Spices | 0.30 ± 0.30 |
| TOTAL | 100.00 |

TABLE 5
Samples 4, 5, and 6 - Soy Patties with Formulations
4, 5, or 6 (Raw Ingredients).

| Soy Patty | Formula (wt %) |
|---|---|
| Protein hydration water | 40.00 ± 15.00 |
| Texturized soy protein | 20.00 ± 12.00 |
| Water for MC emulsion gel | 16.00 ± 9.00 |
| Beef flavors | 4.50 ± 1.00 |
| Sunflower oil | 6.00 ± 3.00 |
| Coconut oil as flakes | 3.50 ± 1.00 |
| Soy protein isolate | 2.00 ± 1.00 |
| Starch/maltodextrin | 2.00 ± 1.00 |
| Methylcellulose | 2.00 ± 1.00 |
| Salt | 1.00 ± 1.00 |
| Food coloring | 1.00 ± 0.50 |
| E Lactic Acid | 0.60 ± 0.40 |
| Yeast Extract | 0.80 ± 0.40 |
| Spices | 0.60 ± 0.30 |
| TOTAL | 100.00 |

### Example 3: Sensory Evaluation and Customer Acceptance of Prepared Soy Patties

Evaluations were all conducted on the same day in 1 session. Three-digit coded samples were presented. Panelists were instructed to evaluate the coded samples in order as presented, from left to right. Panelists were instructed to rinse well with water between samples. Panelists ranked on a 9-point hedonic scale their preferences among the provided samples.

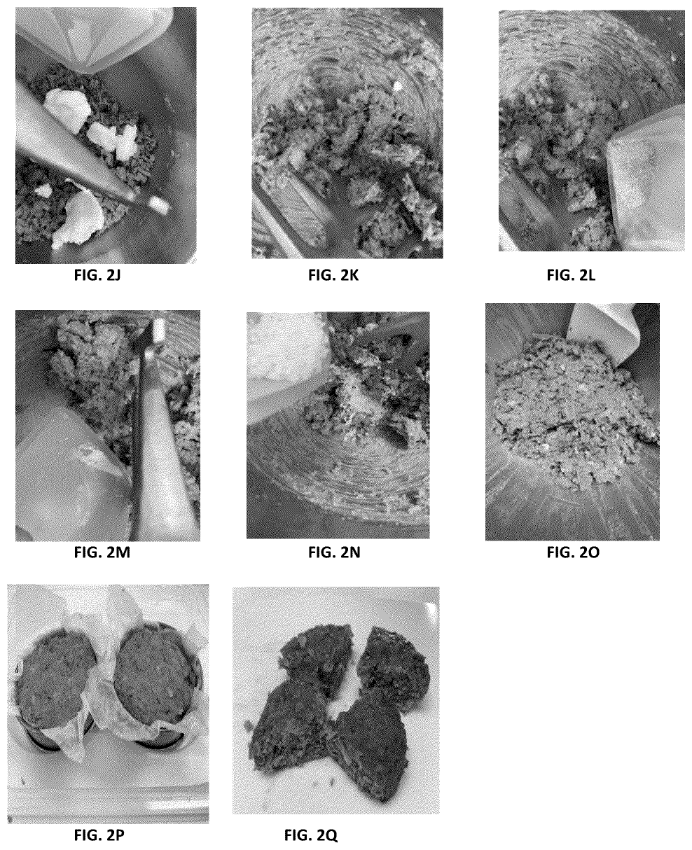

Panelists ranked on a 9-point hedonic scale their preferences among the provided samples. FIG. 3 is an example scale of what each panelist used, where a score of “1” represents a product that's “extremely disliked” and a score of “9” represents a product that is “Extremely liked.” Data was collected using Microsoft forms and analyzed with Excel and R.

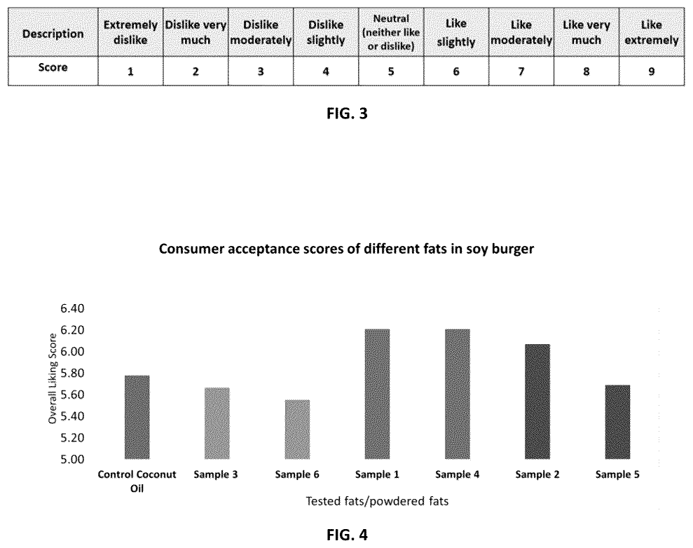

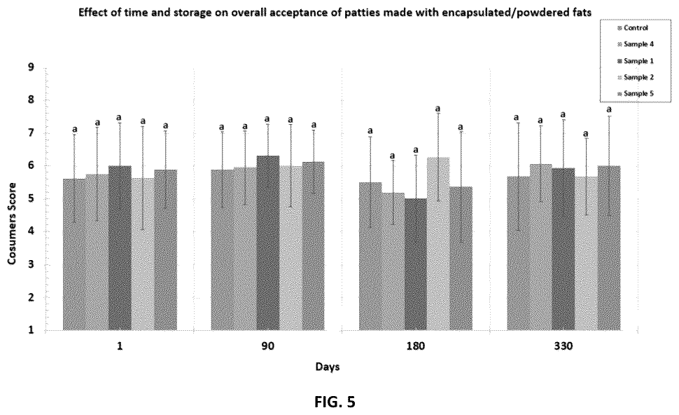

FIG. 4 shows the consumer acceptance scores of different fats in prepared soy patties. Soy patties made with 75% sunflower oil, both with the encapsulated formulation (Sample 1) or without encapsulation (Sample 4), were the most preferred. Samples 1 and 4 were more preferred than Samples 2 and 5. Samples 3 and 6 were the least preferred. Based in these results, Samples 1, 2, 4, and 5 were used for the remaining tests. As shown in FIG. 5, the first sets of the consumer acceptance evaluations at the initial time showed no statistical differences in overall liking between all the tested samples. Still, Sample 1 was the most preferred within this experiment. Per these results, the inventors decided to continue our further testing with Sample 1.

FIG. 5 shows the sensory storage test results at day 1, day 90, day 180, and day 330 m (i.e., eleven months).

No statistical differences among tested samples were observed after eleven months. The lack of statistical significance between the Control and Samples 1, 2, 4, and 5 indicates that consumers like the sample soy patties as much as the Control soy patties.

Soy patties made with the encapsulation formulations (Samples 1 to 3) were shown to have comparable flavor, mouthfeel and texture as the soy patties made with saturated fat, i.e., coconut oil (Control).

Per observations during making soy patties, the sample patties containing the encapsulation formulations (Samples 1 to 3) were more uniformly distributed in the glucose-based polymer or protein matrix and created better visual effect than the soy patties containing unsaturated fat, i.e., coconut oil (Control). About 43.7% less saturated fat per serving was also achieved, without negatively impacting the texture, flavor or appearance of the soy patties containing the encapsulation formulations (Samples 1 to 3) compared to the soy patties containing unsaturated fat, i.e., coconut oil (Control). Better physical characteristics were observed by touch during the process of making and forming the soy patties as well as better storage stability per sensory test results were seen with soy patties containing the encapsulation formulations (Sample 1 to 3) compared to the soy patties containing unsaturated fat, i.e., coconut oil (Control).

1. A plant-based meat composition comprising:
between about 1 wt % to about 5 wt % of an encapsulated formulation that is a spray-dried powder comprising:
about 40% to about 75%, by weight of the encapsulated formulation, of an unsaturated fat;
about 20% to about 50%, by weight of the encapsulated formulation, of at least one glucose-based polymer matrix;
about 10 wt % to about 35 wt % of at least one plant-based protein derived from one or more non-animal sources;
and about 0 wt % to about 10 wt % of saturated fat.

2. The plant-based meat composition of claim 1, wherein the amount of total unsaturated fat in the plant-based meat composition is about 1 wt % to about 10 wt %.

3. The plant-based meat composition of claim 1, wherein the amount of unsaturated fat in the plant-based meat composition is about 0.5 wt % to about 15 wt %.

4. The plant-based meat composition of claim 1, further comprising a vegetable protein extrudate, a fat, a color, a flavor, a texturant, or a combination thereof.

5. The plant-based meat composition of claim 1, further comprising a high moisture meat analogue, wherein the high moisture meat analogue comprises one or more proteins co-extruded with
one or more macro and/or micronutrients and
one or more additives.

6. The plant-based meat composition of claim 1, wherein amount of water in the plant-based meat composition is about 20 wt % to about 60 wt %.

7. The plant-based meat composition of claim 1, wherein the unsaturated fat is olive oil, peanut oil, canola oil, sunflower oil, palm oil, safflower oil, avocado oil, soybean oil, borage oil, evening primrose oil, safflower oil, flaxseed oil, wheat germ oil, grape seed oil, or a combination thereof.

8. The plant-based meat composition of claim 1, wherein the unsaturated fat comprises vitamin A, vitamin D, vitamin E, a tocopherol, a tocotrienol, tocopherols, tocotrienols, vitamin K, beta-carotene, or a combination thereof.

9. The plant-based meat composition of claim 1, wherein amount of water in the encapsulated formulation is about less than 6 wt %.

10. The plant-based meat composition of claim 1, wherein bulk density of the encapsulated formulation is about 0.3 g/cc to about 0.7 g/cc.

11. The plant-based meat composition of claim 1, wherein the glucose-based polymer comprises starch, cellulose, corn syrup, tapioca fiber, inulin, polydextrose, or a combination thereof.

12. The plant-based meat composition of claim 1, wherein the glucose-based polymer comprises food starch modified, maltodextrin, or a combination thereof.

13. The plant-based meat composition of claim 1, wherein the at least one plant-based protein comprises pea protein, acacia, chickpea, soy, oat protein, oat solids, canola protein, barley rice protein, fava bean protein, or a combination thereof.

14. The plant-based meat composition of claim 1, wherein the at least one plant-based protein comprises soy, pea, fava bean, lentils, chickpeas, beans, quinoa, seaweed, algae, or a combination thereof.

15. The plant-based meat composition of claim 1, wherein the unsaturated fat is coated or partially coated with the one or more glucose-based polymer.

16. The plant-based meat composition of claim 1, wherein the percent of protein in the plant-based meat composition is about 10% to about 30%.

17. The plant-based meat composition of claim 1, wherein the percent of protein is about 13 wt % to about 35 wt %, water is about 25 wt % to about 55 wt % and the encapsulated formulation is about 2.5 wt % to about 4.5 wt %.

18. The plant-based meat composition of claim 1, wherein the at least one glucose-based polymer matrix has structure, texture, and/or properties comparable to animal meat.

19. The plant-based meat composition of claim 1, comprising organoleptic characteristics of a meat-based patty.

20. The plant-based meat composition of claim 1, wherein the composition is in the shape of a burger patty, a sausage, a pepperoni, or a bacon.

21. The method of claim 28, wherein the composition is preserved at room temperature at 20° to 22° C.

22. The method of claim 28, wherein the composition is preserved upon refrigeration at 0° to 4° C.

23. The method of claim 28, wherein the composition is preserved upon freezing at −18° to −20° C.

24. The method of claim 28, wherein the plant-based meat composition is cooked or re-heated prior to consumption.

25. (canceled)

26. The plant-based meat composition of claim 20, wherein the plant-based meat composition comprises less than 5.5 g of saturated fat per serving.

27. (canceled)

28. A method of making a plant-based meat composition of claim 1, comprising:
(i) mixing the at least one glucose-based polymer matrix, at least one plant-based protein, and the saturated fat with water;
(ii) spray-drying the product of step (i) with the unsaturated fat.

29. The plant-based meat composition of claim 1, wherein the unsaturated fat comprises sunflower oil.

30. The plant-based meat composition of claim 1, wherein the spray-dried powder comprises a suspension of droplets comprising the unsaturated fat.

31. The plant-based meat composition of claim 1, wherein the unsaturated fat is encapsulated within the one or more glucose-based polymer matrix or a matrix comprising the plant-based protein.

32. The plant-based meat composition of claim 1, wherein the unsaturated fat is in the form of a powder.
